(19) United States
(12) Patent Application Publication
(10) Pub. No.: US 2024/0029427 A1
(43) Pub. Date: Jan. 25, 2024

(54) METHOD FOR DETERMINING UNMANNED AERIAL VEHICLE ACQUISITION VIEWPOINTS, COMPUTER APPARATUS, AND STORAGE MEDIUM

(71) Applicant: SHENZHEN UNIVERSITY, Shenzhen (CN)

(72) Inventors: Hui HUANG, Shenzhen (CN); Yilin Liu, Shenzhen (CN)

(21) Appl. No.: 18/190,433

(22) Filed: Mar. 27, 2023

(30) Foreign Application Priority Data
Jul. 25, 2022 (CN) 202210875100.3

(51) Int. Cl. G06V 20/17; G05D 1/10

(52) U.S. Cl. CPC G06V 20/17; G05D 1/101

(57) ABSTRACT

The present disclosure relates to a method for determining UAV acquisition viewpoints, a computer apparatus, and a storage medium. In the method, target sampling points to be reconstructed are determined from multiple sampling points to be selected on a surface of a scene model based on the reconstructability of the sampling points to be selected. For the target sampling points, multiple new initial acquisition viewpoints are determined. Target acquisition viewpoints are selected from the multiple initial acquisition viewpoints based on viewpoint scores of the initial acquisition viewpoints. The reconstructability of unselected sampling points to be selected are determined. Then the step of determining the target sampling points to be reconstructed based on the reconstructability of the sampling points to be selected and subsequent steps are repeated until a quantity of the sampling points to be selected with the reconstructability less than a preset threshold meets a preset condition.

### CROSS-REFERENCE TO RELATED APPLICATIONS

This application claims priority to Chinese patent application No. 2022108751003, entitled “METHOD AND DEVICE FOR DETERMINING UNMANNED AERIAL VEHICLE ACQUISITION VIEWPOINTS, COMPUTER APPARATUS, AND STORAGE MEDIUM”, filed on Jul. 25, 2022, the entire content of which is incorporated herein by reference.

### TECHNICAL FIELD

This disclosure relates to the computer vision technology, and in particular, to a method for determining Unmanned Aerial Vehicle (UAV) acquisition viewpoints, an electronic apparatus, and a storage medium.

### BACKGROUND

Path planning of aerial photography data acquisition based on three-dimensional (3D) reconstruction of large-scale city scenes has received intensive attention from industry and academia. An eventual aim of the path planning algorithm based on the aerial photography data acquisition is that the acquired data can be reconstructed into a high-quality 3D model. It is very important to determine the acquisition viewpoints accurately and efficiently.

### SUMMARY

In a first aspect, the present disclosure provides a method for determining unmanned aerial vehicle acquisition viewpoints. The method includes the following steps. Target sampling points to be reconstructed are determined from multiple sampling points to be selected on a surface of a scene model based on reconstructabilities of the sampling points to be selected. For the target sampling points, multiple new initial acquisition viewpoints are determined. Target acquisition viewpoints for a reconstruction of the target sampling points are selected from the multiple initial acquisition viewpoints based on viewpoint scores of the initial acquisition viewpoints. Reconstructabilities of unselected sampling points to be selected are determined based on the target acquisition viewpoints, and the step of determining the target sampling points to be reconstructed based on the reconstructabilities of the sampling points to be selected and the subsequent steps are repeated until a quantity of the sampling points to be selected with the reconstructabilities less than a preset threshold meets a preset condition.

In an embodiment, determining the target sampling points to be reconstructed from the multiple sampling points to be selected on the surface of the scene model based on the reconstructabilities of the sampling points to be selected includes the following steps. For each sampling point to be selected on the surface of the scene model, multiple related sampling points within a preset distance from the sampling points to be selected are determined. A sampling probability of the sampling point to be selected is determined based on reconstructabilities of the related sampling points and the reconstructability of the sampling point to be selected. The sampling points to be selected are sampled with the sampling probabilities to obtain the target sampling points to be reconstructed.

In an embodiment, determining the sampling probability of the sampling point to be selected based on the reconstructabilities of the related sampling points and the reconstructability of the sampling point to be selected includes the following steps. Distances between the sampling point to be selected and the related sampling points are determined. Weights of the related sampling points are determined based on the distances. The distances and the weights are negatively related. A weighted summation of the reconstructabilities of the related sampling points is performed in accordance with the corresponding weights to obtain the sampling probability of the sampling point to be selected.

In an embodiment, selecting the target acquisition viewpoints for the reconstruction of the target sampling points from the multiple initial acquisition viewpoints based on the viewpoint scores of the initial acquisition viewpoints includes the following steps. Multiple candidate acquisition viewpoints are selected from the multiple initial acquisition viewpoints based on the viewpoint scores of the initial acquisition viewpoints. Redundancies of the candidate acquisition viewpoints are determined. The candidate acquisition viewpoints with the redundancy greater than a preset redundancy threshold are deleted from the multiple candidate acquisition viewpoints to obtain at least two candidate acquisition viewpoints. The target acquisition viewpoints for the reconstruction of the target sampling points are determined based on the at least two candidate acquisition viewpoints.

In an embodiment, obtaining the target acquisition viewpoints for the reconstruction of the target sampling points based on the at least two candidate acquisition viewpoints includes: for each of the at least two candidate acquisition viewpoints, adjusting a position and an orientation of the candidate acquisition viewpoint using a simple descent method to obtain the target acquisition viewpoints for the reconstruction of the target sampling points.

In an embodiment, before performing the selecting operation to the multiple initial acquisition viewpoints based on the viewpoint scores of the initial acquisition viewpoints, the method further includes the following steps. For each initial acquisition viewpoint, a spatial vector between the initial acquisition viewpoint and the corresponding target sampling point is determined. An angle between the spatial vector and a normal vector of the target sampling point is determined as an acquisition angle of the initial acquisition viewpoint with respect to the corresponding target sampling point. The viewpoint score of the initial acquisition viewpoint is determined based on the acquisition angle. The acquisition angle and the viewpoint score are negatively related.

In an embodiment, each target sampling point has at least one existing acquisition viewpoint. Determining the viewpoint score of the initial acquisition viewpoint based on the acquisition angle includes: determining a viewpoint distance between the at least one existing acquisition viewpoint and the initial acquisition viewpoint; and determining the viewpoint score of the initial acquisition viewpoint based on the acquisition angle and the viewpoint distance.

In a second aspect, the present disclosure further provides a computer apparatus. The computer apparatus includes at least one memory and at least one processor. The at least one memory stores a computer program. When the computer program is executed by the at least one processor, steps of the above method for determining unmanned aerial vehicle acquisition viewpoints are implemented by the processor.

In a third aspect, the present disclosure further provides a non-transitory computer readable storage medium, on which a computer program is stored. When the computer program is executed by at least one processor, steps of the above method for determining unmanned aerial vehicle acquisition viewpoints are implemented.

### BRIEF DESCRIPTION OF THE DRAWINGS

FIG. 1 is a diagram showing an application environment of a method for determining UAV acquisition viewpoints according to an embodiment.

FIG. 2 is a schematic diagram of a flowchart of a method for determining UAV acquisition viewpoints according to an embodiment.

FIG. 3 is a schematic diagram of a principle of a method for determining UAV acquisition viewpoints according to an embodiment.

FIG. 4 is a schematic diagram of a principle of a method for determining UAV acquisition viewpoints according to an embodiment.

FIG. 5 is a schematic diagram of a principle of a method for determining UAV acquisition viewpoints according to an embodiment.

FIG. 6 is a diagram showing a comparation of effects of methods for determining UAV acquisition viewpoints according to an embodiment.

FIG. 7 is a diagram showing a comparation of effects of methods for determining UAV acquisition viewpoints according to an embodiment.

FIG. 8 is a block diagram of a structure of a device for determining UAV acquisition viewpoints according to an embodiment.

FIG. 9 is a diagram of an internal structure of a computer apparatus according to an embodiment.

FIG. 10 is a diagram of an internal structure of a computer apparatus according to an embodiment.

### DETAILED DESCRIPTION OF THE EMBODIMENTS

In order to make the purpose, technical solutions and advantages of the present disclosure more clear, the present disclosure will be further described in detail below with reference to the accompanying drawings and embodiments. It should be understood that the specific embodiments described herein are only used to explain the present disclosure, but not to limit the present disclosure.

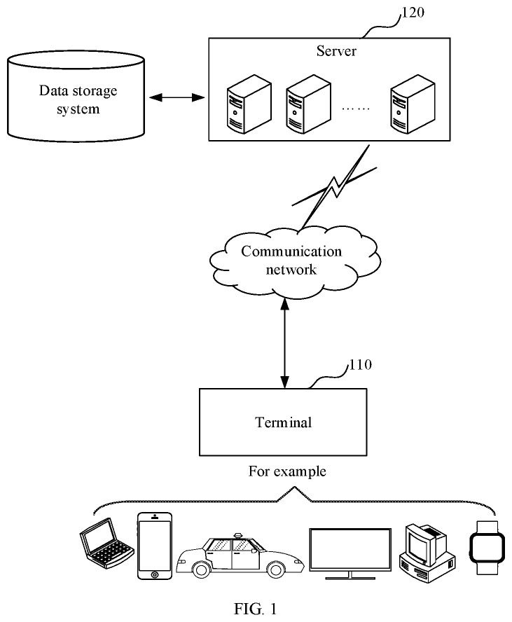

The method for determining UAV acquisition viewpoints provided in the embodiments of the present disclosure may be applied to an application environment shown in FIG. 1. In the application environment, a terminal 110 communicates with a server 120 through a network. A data storage system may store data to be processed by the server 120. The data storage system may be integrated in the server 120, or placed in a cloud server or other network servers. The terminal 110 may be, but is not limited to, various personal computers, laptops, smartphones, tablets, and portable wearable devices. The server 120 may be implemented with an independent server, or a server cluster composed of multiple servers.

The server 120 can generate a scene model based on an image obtained by capturing a real scene. The server 120 determines target sampling points to be reconstructed from multiple sampling points to be selected on the surface of the scene model based on reconstructabilities of the sampling points to be selected. The server 120 determines multiple new initial acquisition viewpoints for the target sampling points. The server 120 selects target acquisition viewpoints for the reconstruction of the target sampling points from the initial acquisition viewpoints based on viewpoint scores of the initial acquisition viewpoints. The server 120 determines the reconstructabilities of unselected sampling points to be selected based on the target acquisition viewpoints, and repeats the step of determining the target sampling points to be reconstructed based on the reconstructabilities of the sampling points to be selected and the subsequent steps until a quantity of the sampling points to be selected with the reconstructabilities less than a preset threshold meets a preset condition. The server 120 sends the target acquisition viewpoints to the terminal 110, enabling the terminal 110 to generate a corresponding aerial photography data acquisition path based on the multiple target acquisition viewpoints.

In an embodiment, the terminal 110 may also be replaced by a server. The terminal 110 is not limited in the present disclosure.

In another embodiment, the server 120 may also be replaced by a terminal. The server 120 is not limited in the present disclosure.

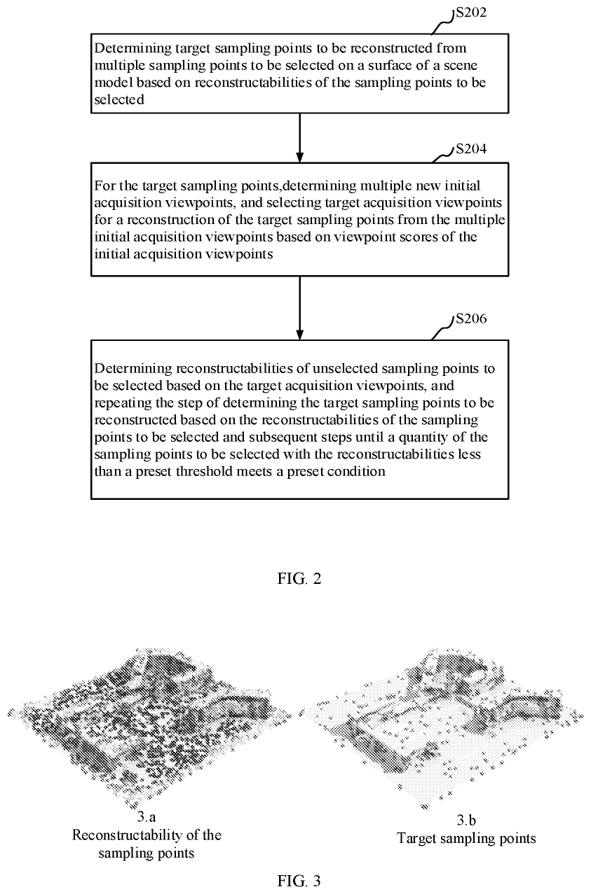

In an embodiment, as shown in FIG. 2, a method for determining the UAV acquisition viewpoints is provided. This embodiment will be illustrated by taking the method applied to a server as an example. It should be understood that the method may also be applied to the terminal. The method may also be applied to a system including the terminal and the server, and implemented by interactions of the terminal and the server. In this embodiment, the method includes the following steps.

At step S202, target sampling points to be reconstructed are determined from multiple sampling points to be selected on a surface of a scene model based on reconstructabilities of the sampling points to be selected.

In detail, the server can determine the reconstructabilities of the multiple sampling points to be selected on the surface of the scene model, and determine the target sampling points to be reconstructed from the multiple sampling points to be selected based on the reconstructabilities of the sampling points to be selected.

In an embodiment, the reconstructabilities of the sampling points to be selected are obtained based on a spatial relationship between existing acquisition viewpoints of the sampling points to be selected and the sampling points to be selected.

In an embodiment, the server may determine sampling probabilities of the sampling points to be selected based on the reconstructabilities of multiple related sampling points located in the same area as the sampling points to be selected, and sample the sampling points to be selected with the sampling probabilities of the sampling points to be selected to obtain the target sampling points.

In an embodiment, the server can determine weights of the related sampling points based on the distances between the sampling points to be selected and the related sampling points, and perform a weighted summation of the reconstructabilities of the related sampling points in accordance with the corresponding weights to obtain the sampling probabilities.

At step S204, for the target sampling points, multiple new initial acquisition viewpoints are determined, and target acquisition viewpoints for the reconstruction of the target sampling points are selected from the initial acquisition viewpoints based on viewpoint scores of the initial acquisition viewpoints.

In detail, for the target sampling points, the server determines the multiple new initial acquisition viewpoints. The server determines the viewpoint score of each initial acquisition viewpoint, and selects the target acquisition viewpoints for the reconstruction of the target sampling points from the initial acquisition viewpoints based on the viewpoint scores of the initial acquisition viewpoints. It should be understood that the target acquisition viewpoints are the initial acquisition viewpoints with viewpoint scores greater than a preset threshold.

In an embodiment, for each initial acquisition viewpoint, if there is no existing acquisition viewpoint for the initial acquisition viewpoint, the server can determine the viewpoint score of the initial acquisition viewpoint based on an acquisition angle of the initial acquisition viewpoint with respect to a corresponding target sampling point.

In an embodiment, for each initial acquisition viewpoint, if there is an existing acquisition viewpoint for the initial acquisition viewpoint, the server can determine the viewpoint score of the initial acquisition viewpoint based on an acquisition angle of the initial acquisition viewpoint with respect to the corresponding target sample point, and a distance between the existing acquisition viewpoint and the initial acquisition viewpoint.

In an embodiment, the server can select candidate acquisition viewpoints from the multiple initial acquisition viewpoints based on the viewpoint scores. Compared with determining the candidate acquisition viewpoints by random sampling, selecting the candidate acquisition viewpoints based on the viewpoint scores can improve the effectiveness of the candidate acquisition viewpoints. The server can perform a further selection operation to the candidate acquisition viewpoints according to redundancies of the candidate acquisition viewpoints, and adjust the positions and orientations of the selected candidate acquisition viewpoints using a simple descent method to obtain the target acquisition viewpoints.

At step S206, reconstructabilities of unselected sampling points to be selected are determined based on the target acquisition viewpoints, and the step of determining the target sampling points to be reconstructed based on the reconstructabilities of the sampling points to be selected and the subsequent steps are repeated until a quantity of the sampling points to be selected with the reconstructabilities less than a preset threshold meets a preset condition.

In detail, the server determines the reconstructabilities of the unselected sampling points to be selected based on the target acquisition viewpoints, and determines the unselected sampling points to be selected as new sampling points to be selected. Then the server repeats the step of determining the target sampling points to be reconstructed based on the reconstructabilities of the sampling points to be selected and the subsequent steps until the quantity of the sampling points to be selected with the reconstructabilities less than the preset threshold meets the preset condition. For example, the iterative process is stopped when a ratio of the quantity of the sampling points to be selected with the reconstructabilities less than the preset threshold to a total number of all sampling points on the scene model is less than or equal to a preset ratio threshold. It should be understood that the selected target sampling points will not be selected again during the iterative process.

In an embodiment, the process of determining the reconstructabilities of the unselected sampling points to be selected based on the target acquisition viewpoints includes: taking the target acquisition viewpoints as the existing acquisition viewpoints, and determining the reconstructabilities of the unselected sampling points to be selected based on the existing acquisition viewpoints by the server. It should be understood that the quantity of the existing acquisition viewpoints increases with the number of the iterative process.

In the above method for determining the UAV acquisition viewpoints, the target sampling points to be reconstructed are determined from the multiple sampling points to be selected on the surface of the scene model based on the reconstructabilities of the sampling points to be selected. It can be understood that the target sampling points are the sampling points with high reconstructabilities. For the target sampling points, the multiple new initial acquisition viewpoints are determined. The target acquisition viewpoints for the reconstruction of the target sampling points are selected from the multiple initial acquisition viewpoints based on the viewpoint scores of the initial acquisition viewpoints. The reconstructabilities of the unselected sampling points to be selected are determined based on the target acquisition viewpoints. The step of determining the target sampling points to be reconstructed based on the reconstructabilities of the sampling points to be selected and the subsequent steps are repeated until the quantity of the sampling points to be selected with the reconstructabilities less than the preset threshold meets the preset condition. Therefore, the target acquisition viewpoints can be determined iteratively based on the reconstructabilities of the target sampling points and the viewpoint scores of the initial acquisition viewpoints, thus improving the effectiveness of the target acquisition viewpoints.

In an embodiment, determining the target sampling points to be reconstructed from the multiple sampling points to be selected on the surface of the scene model based on the reconstructabilities of the sampling points to be selected includes the following steps. For each sampling point to be selected on the surface of the scene model, multiple related sampling points within a preset distance from the sampling point to be selected are determined, and the sampling probability of the sampling point to be selected is determined based on the reconstructabilities of the related sampling points and the reconstructability of the sampling point to be selected. The sampling points to be selected are sampled with the sampling probabilities to obtain the target sampling points to be reconstructed.

In detail, for each sampling point to be selected on the surface of the scene model, the server determines the multiple related sampling points within the preset distance from the sampling point to be selected, and determines the sampling probability of the sampling point to be selected based on the reconstructabilities of the related sampling points and the reconstructability of the sampling points to be selected. The server samples the sampling points to be selected with the sampling probabilities to obtain the target sampling points to be reconstructed.

For example, as shown in FIG. 3, in subfigure 3.a, different colors are used to indicate the reconstructabilities of different sampling points to be selected. Subfigure 3.b shows the target sampling points determined based on the reconstructabilities. It should be understood that, compared with the method of obtaining the target sampling points by uniform sampling, a higher resolution can be achieved for the areas difficult to reconstruct by using the reconstructabilities to calculate the sampling probabilities, and sampling the sampling points to be selected with the sampling probabilities.

In this embodiment, the sampling probabilities are determined based on the reconstructabilities of the multiple related sampling points within the preset distance, thus the target sampling points are determined by the probabilistic sampling, which improves the accuracy and the effectiveness of the target sampling points.

In an embodiment, for each sampling point to be selected, determining the sampling probability of the sampling point to be selected based on the reconstructabilities of the related sampling points and the reconstructability of the sampling point to be selected includes the following steps. The distances between the sampling point to be selected and the related sampling points are determined. The weights of the related sampling points are obtained based on the distances. The distances and the weights are negatively related. The weighted summation of the reconstructabilities of the related sampling points is performed in accordance with the corresponding weights to obtain the sampling probability of the sampling point to be selected.

In detail, for each sampling point to be selected, the server determines the distances between the sampling point to be selected and the related sampling points. The server obtains the weights of the related sampling points based on the distances. The distances and the weights are negatively related. In other words, the greater the distance, the smaller the weight. The smaller the distance, the greater the weight. The server performs the weighted summation of the reconstructabilities of the related sampling points in accordance with the corresponding weights to obtain the sampling probabilities of the sampling points to be selected.

For example, for each sampling point to be selected pⱼ on the surface of the scene model, the corresponding sampling probability is Probₚⱼ. Pₙ is a set of sampling points within the preset distance from the sampling point to be selected pⱼ (including the sampling points to be selected and the related sampling points). The server can calculate the sampling probability Probₚⱼ based on the reconstructability R_{q} of each sampling point q in Pₙ. The specific formula is as follows:

$${Prob}_{pj} = \frac{{Σ}_{q ∈ {P}_{n}} {R}_{q} {e}^{- {d}_{q}}}{\vert {P}_{n} \vert}$$

In the formula, d_{q} is the distance from a sampling point q in the set Pₙ to the sampling point to be selected pⱼ. It should be understood that the greater the distance, the smaller the weight. The smaller the distance, the greater the weight. The weighted summation of the reconstructabilities is calculated based on the weights, and the sampling probability is obtained by calculating an average of the summation results.

In this embodiment, the sampling probabilities of the sampling points to be selected are obtained by the weighted summation of the reconstructabilities of the related sampling points in accordance with the corresponding weights, thereby improving the accuracy of the sampling probabilities.

In an embodiment, selecting the multiple target acquisition viewpoints for the reconstruction of the target sampling points from the multiple initial acquisition viewpoints based on the viewpoint scores of the initial acquisition viewpoints includes the following steps. The multiple candidate acquisition viewpoints are selected from the multiple initial acquisition viewpoints based on the viewpoint scores of the initial acquisition viewpoints. Redundancies of the candidate acquisition viewpoints are determined. The candidate acquisition viewpoints with the redundancy greater than a preset redundancy threshold are deleted from the multiple candidate acquisition viewpoints to obtain at least two candidate acquisition viewpoints. The target acquisition viewpoints for the reconstruction of the target sampling points are obtained based on the at least two candidate acquisition viewpoints.

In detail, the server selects the multiple candidate acquisition viewpoints from the multiple initial acquisition viewpoints based on the viewpoint scores of the initial acquisition viewpoints. Furthermore, the server determines the redundancy of each candidate acquisition viewpoint, and deletes the candidate acquisition viewpoints with the redundancy greater than the preset redundancy threshold from the multiple candidate acquisition viewpoints to obtain the at least two candidate acquisition viewpoints. The server obtains the target acquisition viewpoints for the reconstruction of the target sampling points based on the at least two candidate acquisition viewpoints.

In this embodiment, the candidate acquisition viewpoints with the redundancy greater than the preset redundancy threshold are deleted by calculating the redundancies of the candidate acquisition viewpoints, thereby reducing the redundancy of the viewpoints, and improving effectiveness of the acquisition viewpoints.

In an embodiment, obtaining the target acquisition viewpoints for the reconstruction of the target sampling points based on the at least two candidate acquisition viewpoints includes: for each of the at least two candidate acquisition viewpoints, adjusting the position and the orientation of the candidate acquisition viewpoint using the simple descent method to obtain the target acquisition viewpoints for the reconstruction of the target sampling points.

In detail, for each of the at least two candidate acquisition viewpoints, the server adjusts the position and the orientation of the candidate acquisition viewpoint using the simple descent method, and determines the adjusted candidate acquisition viewpoint as the target acquisition viewpoint for the reconstruction of the target sampling points.

In this embodiment, the accuracy of the reconstructabilities of the target sampling points can be further improved by using the simple descent method to adjust the positions and the orientations of the candidate acquisition viewpoints.

In an embodiment, before performing the selecting operation to the multiple initial acquisition viewpoints based on the viewpoint scores of the initial acquisition viewpoints, the method further includes the following steps. For each initial acquisition viewpoint, a spatial vector between the initial acquisition viewpoint and the corresponding target sampling point is determined. An angle between the spatial vector and a normal vector of the corresponding target sampling point is determined as an acquisition angle of the initial acquisition viewpoint with respect to the corresponding target sampling point. The viewpoint score of the initial acquisition viewpoint is determined based on the acquisition angle. The acquisition angle and the viewpoint score are negatively related.

The normal vector is perpendicular to the surface of the scene model and passes through the target sampling point.

In detail, before performing the selecting operation to the multiple initial acquisition viewpoints based on the viewpoint scores of the initial acquisition viewpoints, for each initial acquisition viewpoint, the server determines the spatial vector between the initial acquisition viewpoint and the corresponding target sampling point. The server determines the angle between the spatial vector and the normal vector of the corresponding target sampling point as the acquisition angle of the initial acquisition viewpoint with respect to the corresponding target sampling point. The server determines the viewpoint score of the initial acquisition viewpoint based on the acquisition angle. The acquisition angle and the viewpoint score are negatively related. In other words, the greater the acquisition angle, the lower the viewpoint score. The smaller the acquisition angle, the higher the viewpoint score. It should be understood that a smaller acquisition angle means that the vector between the initial acquisition viewpoint and the target sampling point is closer to the vertical direction of 90 degrees, the image acquired by the initial acquisition viewpoints is better, and therefore the viewpoint score is greater.

In this embodiment, the acquisition angle and the viewpoint score are negatively related, which can improve the accuracy of the viewpoint scores, so that effective target acquisition viewpoints can be selected.

In an embodiment, each target sampling point has at least one existing acquisition viewpoint. For each initial acquisition viewpoint, determining the viewpoint score of the initial acquisition viewpoint based on the acquisition angle includes: determining a viewpoint distance between the at least one existing acquisition viewpoint and the initial acquisition viewpoint, and determining the viewpoint score of the initial acquisition viewpoint based on the acquisition angle and the viewpoint distance. The viewpoint distance and the viewpoint score are positively related.

In detail, each target sampling point has at least one existing acquisition viewpoint. For each initial acquisition viewpoint, the server can determine the viewpoint distance between the at least one existing acquisition viewpoint and the initial acquisition viewpoint, and determine the viewpoint score of the initial acquisition viewpoint based on the acquisition angle and the viewpoint distance. The viewpoint distance and the viewpoint score are positively related. In other words, the larger the viewpoint distance, the higher the viewpoint score.

In an embodiment, the server can determine the viewpoint distance between each existing acquisition viewpoint and the initial acquisition viewpoint respectively, obtain a minimum viewpoint distance from the multiple viewpoint distances, and obtain the viewpoint score based on the minimum viewpoint distance and the acquisition angle. The minimum viewpoint distance and the viewpoint score are positively related.

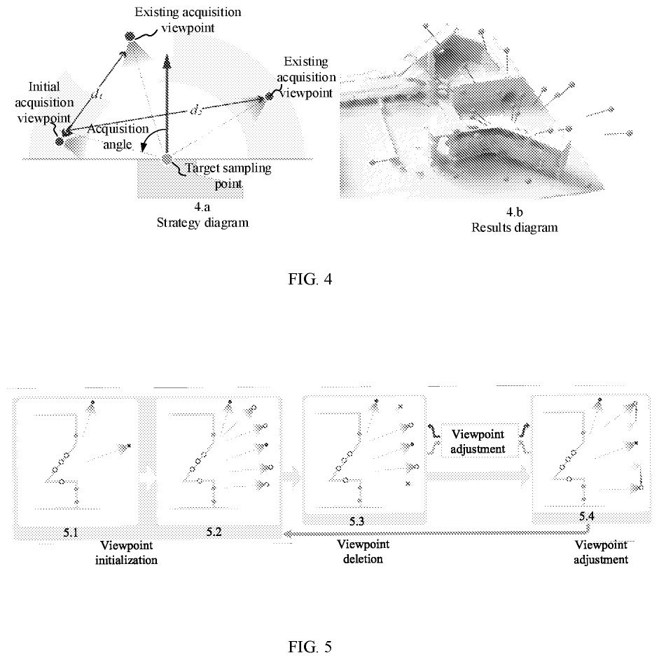

In an embodiment, as shown in subfigure 4.a of FIG. 4, a target sampling point corresponds to two existing acquisition viewpoints and one initial acquisition viewpoint. Vv indicates the two existing acquisition viewpoints, and Vₘ indicates the initial acquisition viewpoint. A viewpoint score Score_{V}_{ₘ} of the initial acquisition viewpoint Vₘ is calculated according to the following formula:

$${Score}_{{V}_{m}} = dot ( {V}_{m} - {x}_{j} , {n}_{j} ) * {min}_{{V}_{V} ∈ {V}_{V}} dot ( {V}_{m} - {x}_{j} , {V}_{V} - {x}_{j} )$$

In the above formula, xⱼ and nⱼ are the position and the normal vector of the target sampling point pⱼ, respectively. The formula indicates that the closer the initial acquisition viewpoint is to the normal vector of the target sampling point pⱼ, and the further away the initial acquisition viewpoint is from the existing acquisition viewpoints, the better it is. For example, for the two viewpoint distances d1 and d2 in subfigure 4.a, the server can obtain the viewpoint score based on these two viewpoint distances, so that the viewpoint score and the viewpoint distances are positively related. In this manner, the target acquisition viewpoints selected based on the viewpoint scores are shown in subfigure 4.b.

In an embodiment, as shown in FIG. 5, a process of determining the acquisition viewpoints includes three major parts: a viewpoint initialization phase, a viewpoint deletion phase, and a viewpoint adjustment phase. In detail, in the viewpoint initialization phase, the server determines the target sampling points to be reconstructed from multiple sampling points to be selected on the surface of the scene model based on the reconstructabilities of the sampling points to be selected. Each of the target sampling points can have existing acquisition viewpoints. For example, the two viewpoints shown in subfigure 5.1 are the existing acquisition viewpoints. For each target sampling point, the server determines multiple new initial acquisition viewpoints, such as the new initial acquisition viewpoints shown in subfigure 5.2. In the viewpoint deletion phase, for each initial acquisition viewpoint, the server determines a spatial vector between the initial acquisition viewpoint and the target sampling point, and determines an angle between the spatial vector and a normal vector of the target sampling point as an acquisition angle of the initial acquisition viewpoint with respect to the target sampling point. The server determines the viewpoint score of the initial acquisition viewpoint based on the acquisition angle. If there is an existing acquisition viewpoint, the server can further determine a viewpoint distance between the existing acquisition viewpoint and the initial acquisition viewpoint, and determine a viewpoint score for the initial acquisition viewpoint based on the acquisition angle and the viewpoint distance. The viewpoint distance and the viewpoint score are positively related. The server selects the multiple candidate acquisition viewpoints from the multiple initial acquisition viewpoints based on the viewpoint scores of the initial acquisition viewpoints. The server determines the redundancies of the candidate acquisition viewpoints, and deletes the candidate acquisition viewpoints with the redundancy greater than the preset redundancy threshold from the multiple candidate acquisition viewpoints to obtain at least two candidate acquisition viewpoints. As shown in subfigure 5.3, compared with subfigure 5.2, two candidate acquisition viewpoints have been deleted. In the viewpoint adjustment phase, for each of the at least two candidate acquisition viewpoints, the server can adjust the position and the orientation of the candidate acquisition viewpoint using the simple descent method to obtain the target acquisition viewpoints for the reconstruction of the target sampling points. For example, compared with subfigure 5.3, the candidate acquisition viewpoints in subfigure 5.4 are adjusted in the position and the orientation. The server returns to the viewpoint initialization phase for an iterative process. In detail, the server determines the reconstructabilities of unselected sampling points to be selected based on the target acquisition viewpoints, and repeats the step of determining the target sampling points to be reconstructed based on the reconstructabilities of the sampling points to be selected and the subsequent steps until the quantity of the sampling points to be selected with the reconstructabilities less than the preset threshold meets the preset condition. It should be understood that, in the continuous iterative process, the unselected sampling points to be selected become less and less, the acquisition viewpoints become more and more, and the reconstructability of the target scene corresponding to the scene model will gradually increase, especially for the areas with complex geometric structures. Compared with other related methods for determining the acquisition viewpoints, selecting the new target sampling points and determining the target acquisition viewpoints based on the reconstructabilities can better avoid the local minima in the iterative process.

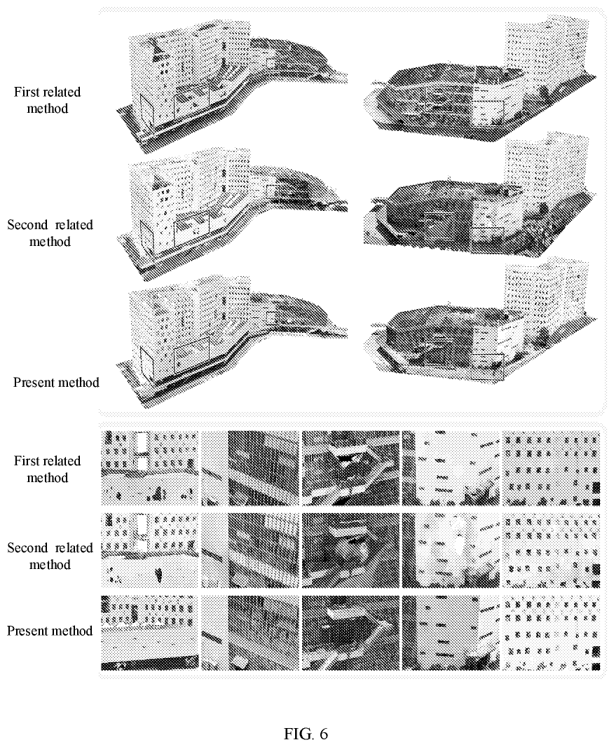

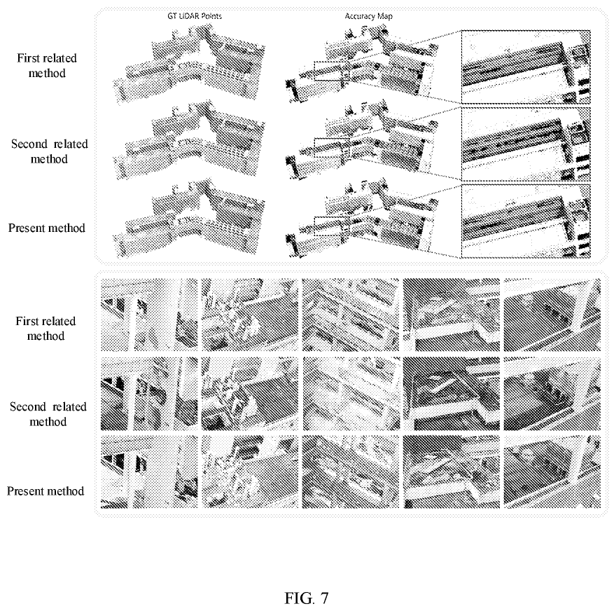

The present disclosure has been experimented in several scenes and compared with a first related method and a second related method. Reconstruction results using different methods on different scenes are shown in FIG. 6 and FIG. 7. The reconstruction results are shown in the entire figure in each column, and the subfigures show the details of the reconstruction results obtained by the present disclosure compared with the related methods. From the results, it can be seen that the paths generated by the present disclosure using the target acquisition viewpoints can achieve a better reconstruction quality.

In the present disclosure, an accuracy-completeness metric for a 3D scene reconstruction task of a city is further tested. The accuracy-completeness is a common metric for the 3D scene reconstruction of cities, which can measure the accuracy of the reconstruction of unknown scenes. Upon experiments, in two test scenarios, 90% of the errors of the 3D model reconstructed by the present method are below 0.333 m and 0.352 m, which is improved by 23% and 21% compared to the first related method and the second related method, respectively. It is proved that the aerial photography path generated by the present disclosure using the target acquisition viewpoints can achieve a better reconstruction effect.

It should be understood that, although the steps in the flowcharts involved in the above embodiments are sequentially shown by the indications of the arrows, these steps are not necessarily executed in the order indicated by the arrows. Unless explicitly stated herein, the execution of these steps is not strictly limited to the order, and the steps may be executed in other orders. Moreover, at least a part of the steps in the flowcharts involved in the above embodiments may include multiple steps or multiple stages, and these steps or stages are not necessarily executed and completed at the same time, but may be performed at different times. The execution order of these steps or stages is not necessarily sequential, but may be performed alternately or in turn with other steps or at least a part of the steps or stages of the other steps.

Based on the same concept, the embodiments of the present disclosure further provide a device for determining UAV acquisition viewpoints, which is configured for implementing the method for determining the UAV acquisition viewpoints. The solution provided by the device for solving the problem is similar to the solution provided by the method described above, therefore, the specific features in one or more embodiments of the device for determining the UAV acquisition viewpoints provided below can be refered to the features of the above method for determining the UAV acquisition viewpoints, and will not be repeated here.

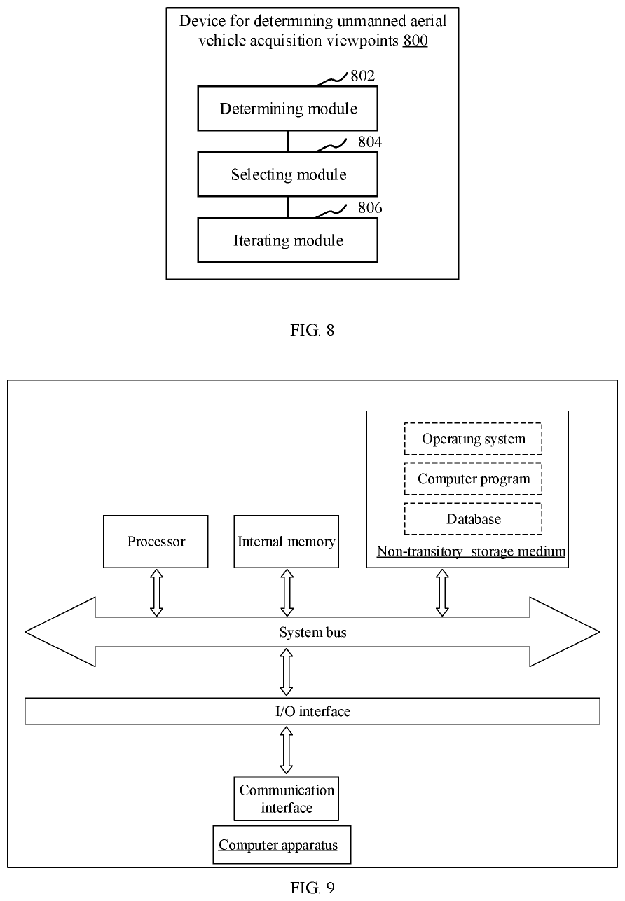

In an embodiment, as shown in FIG. 8, a device 800 for determining UAV acquisition viewpoints is provided. The device 800 includes a determining module 802, a selecting module 804, and an iterating module 806.

The determining module 802 is configured to determine target sampling points to be reconstructed from multiple sampling points to be selected on a surface of a scene model based on reconstructabilities of the sampling points to be selected.

The selecting module 804 is configured to determine multiple new initial acquisition viewpoints for the target sampling points, and select target acquisition viewpoints for the reconstruction of the target sampling points from the initial acquisition viewpoints based on viewpoint scores of the initial acquisition viewpoints.

The iterating module 806 is configured to determine reconstructabilities of unselected sampling points to be selected based on the target acquisition viewpoints, and return to the step of determining the target sampling points to be reconstructed based on the reconstructabilities of the sampling points to be selected and the subsequent steps until a quantity of the sampling points to be selected with the reconstructabilities less than a preset threshold meets a preset condition.

In an embodiment, the determining module 802 is further configured to determine, for each sampling point to be selected on the surface of the scene model, multiple related sampling points within a preset distance from the sampling point to be selected. The determining module 802 further determines sampling probabilities of the sampling points to be selected based on the reconstructabilities of the related sampling points and the reconstructabilities of the sampling points to be selected. Then, the determining module 802 samples the sampling points to be selected with the sampling probabilities to obtain the target sampling points to be reconstructed.

In an embodiment, for each sampling point to be selected, the determining module 802 is further configured to determine the distances between the sampling point to be selected and the related sampling points, and obtain the weights of the related sampling points based on the distances. The distances and the weights are negatively related. The determining module 802 further performs a weighted summation of the reconstructabilities of the related sampling points in accordance with the corresponding weights to obtain the sampling probability of the sampling point to be selected.

In an embodiment, the selecting module 804 is further configured to select multiple candidate acquisition viewpoints from the multiple initial acquisition viewpoints based on the viewpoint scores of the initial acquisition viewpoints. The selecting module 804 further determines redundancies of the candidate acquisition viewpoints, and deletes the candidate acquisition viewpoints with the redundancy greater than a preset redundancy threshold from the multiple candidate acquisition viewpoints to obtain at least two candidate acquisition viewpoints. Then, the selecting module 804 determines the target acquisition viewpoints for the reconstruction of the target sampling points based on the at least two candidate acquisition viewpoints.

In an embodiment, for each of the at least two candidate acquisition viewpoints, the selecting module 804 is further configured to adjust a position and an orientation of the candidate acquisition viewpoint using a simple descent method to obtain the target acquisition viewpoints for the reconstruction of the target sampling points.

In an embodiment, before performing the selecting operation to the multiple initial acquisition viewpoints based on the viewpoint scores of the initial acquisition viewpoints, for each initial acquisition viewpoint, the selecting module 804 is further configured to determine a spatial vector between the initial acquisition viewpoint and the corresponding target sampling point, and determine an angle between the spatial vector and a normal vector of the target sampling point as an acquisition angle of the initial acquisition viewpoint with respect to the corresponding target sampling point. The selecting module 804 further determines the viewpoint score of the initial acquisition viewpoint based on the acquisition angle. The acquisition angle and the viewpoint score are negatively related.

In an embodiment, each target sampling point has at least one existing acquisition viewpoint. For each initial acquisition viewpoint, the selecting module 804 is further configured to determine a viewpoint distance between the at least one existing acquisition viewpoint and the initial acquisition viewpoint, and determine the viewpoint score of the initial acquisition viewpoint based on the acquisition angle and the viewpoint distance. The viewpoint distance and the viewpoint score are positively related.

In the above device for determining the UAV acquisition viewpoints, the target sampling points to be reconstructed are determined from the multiple sampling points to be selected on the surface of the scene model based on the reconstructabilities of the sampling points to be selected. It can be understood that the target sampling points are the sampling points with higher reconstructabilities. For the target sampling points, the multiple new initial acquisition viewpoints are determined. The target acquisition viewpoints for the construction of the target sampling points are selected from the multiple initial acquisition viewpoints based on the viewpoint scores of the initial acquisition viewpoints. The reconstructabilities of the unselected sampling points to be selected are determined based on the target acquisition viewpoints. The step of determining the target sampling points to be reconstructed based on the reconstructabilities of the sampling points to be selected and the subsequent steps are repeated until the quantity of the sampling points to be selected with the reconstructabilities less than a preset threshold meets a preset condition. Therefore, the target acquisition viewpoints can be determined iteratively based on the reconstructabilities of the target sampling points and the viewpoint scores of the initial acquisition viewpoints, thus improving the effectiveness of the target acquisition viewpoints.

The specific features of the above device for determining the UAV acquisition viewpoints can be referred to the above features of the above method for determining the UAV acquisition viewpoints, which will not be repeated here. The modules of the above device for determining the UAV acquisition viewpoints may be implemented in whole or in part by software, hardware, and combinations thereof. Each of the above modules may be embedded in or independent of a processor in a computer device in a form of hardware, or may be stored in a memory of the computer device in a form of software, so that the processor may be called to perform the operations corresponding to the above modules.

In an embodiment, the present disclosure further provides a computer apparatus, which may be a server. An inner structure of the computer apparatus is shown in FIG. 9. The computer apparatus includes a processor, a memory, an input/output (I/O) interface, a communication interface. The processor, the memory and the input/output interface are connected through a system bus, and the communication interface is connected to the system bus through the input/output interface. The processor of the computer apparatus is configured to provide computing and control capabilities. The memory of the computer apparatus includes a non-transitory storage medium and an internal memory. The non-transitory storage medium stores an operating system and a computer program. The internal memory provides an environment for the operation of the operating system and the computer program in the non-transitory storage medium. The input/output interface of the computer apparatus is configured to exchange information between the processor and external devices. The communication interface of the computer apparatus is configured to communicate with external terminals through a network connection. The computer program implements the method for determining the UAV acquisition viewpoints when executed by the processor.

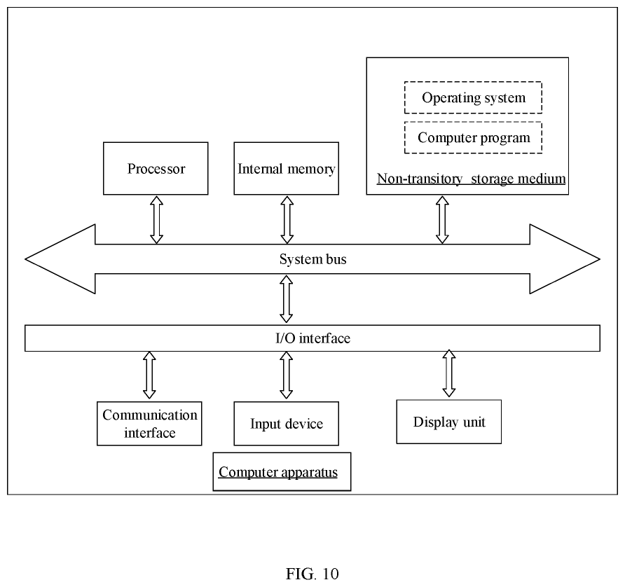

In an embodiment, the present disclosure further provides a computer apparatus, which may be a terminal. An inner structure of the computer apparatus is shown in FIG. 10. The computer apparatus includes a processor, a memory, an input/output interface, a communication interface, a display unit, and an input device. The processor, the memory and the input/output interface are connected through a system bus, and the communication interface, the display unit and the input device are connected to the system bus through the input/output interface. The processor of the computer apparatus is configured to provide computing and control capabilities. The memory of the computer apparatus may include a non-transitory storage medium and an internal memory. The non-transitory storage medium stores an operating system and a computer program. The internal memory provides an environment for the operation of the operating system and the computer program in the non-transitory storage medium. The input/output interface of the computer apparatus is configured to exchange information between the processor and external devices. The communication interface of the computer apparatus is configured to be in wired or wireless communication with external terminals, and the wireless communication can be realized by wireless fidelity (Wi-Fi), mobile cellular network, near field communication (NFC) or other technologies. The computer program can be executed by the processor to implement the method for determining the UAV acquisition viewpoints. The display unit of the computer apparatus is configured to form a visually visible picture. The display unit may be a display screen, a projection device, or a virtual reality imaging device. The display screen may be a liquid crystal display screen or an electronic ink display screen. The input device of the computer apparatus may be a touch layer covered on the display screen, and may also be keys, trackballs or touchpads provided on a housing of the computer apparatus, and may also be an external keyboard, a touchpad, or a mouse.

Those skilled in the art should understand that the structures shown in FIG. 9 and FIG. 10 are only block diagrams of a part of the structures related to the solution of the present disclosure, and do not constitute a limitation on the computer apparatus to which the solution of the present disclosure is applied. A specific computer apparatus can include more or fewer components, combine certain components, or have a different arrangement of components.

In one embodiment, a computer apparatus is further provided. The computer apparatus includes at least one memory and at least one processor. The at least one memory stores a computer program. The at least one processor implements the steps of the methods in the above embodiments when executing the computer program.

In an embodiment, a non-transitory computer readable storage medium is provided. The computer readable storage medium stores a computer program, the steps of the methods in the above embodiments are implemented when the computer program is executed by at least one processor.

In an embodiment, a computer program product is provided. The computer program product includes a computer program, the steps of the methods in the above embodiments are implemented when the computer program is executed by at least one processor.

In the method for determining UAV acquisition viewpoints, the computer apparatus, and the storage medium provided by the present disclosure, the UAV acquisition viewpoints are determined by iteratively adding, eliminating and adjusting based on the reconstructability of the target sampling points. Target sampling points to be reconstructed are determined from multiple sampling points to be selected on a surface of a scene model based on the reconstructability of the sampling points to be selected. For the target sampling points, multiple new initial acquisition viewpoints are determined. A subset of the initial acquisition viewpoints is added to the existing viewpoint set based on viewpoint scores of the initial acquisition viewpoints. Based on the reconstructability of the target sampling points, a subset of the existing viewpoints are chosen to eliminate the redundancy of the acquisition route. Finally, the position and the direction of the acquisition viewpoints are modified based on the reconstructability of target sampling points. The step of determining the target sampling points to be reconstructed based on the reconstructability of the sampling points to be selected and subsequent steps are repeated until a quantity of the sampling points to be selected with the reconstructability less than a preset threshold meets a preset condition.

Those of ordinary skill in the art can understand that all or part of the processes of the methods of the above embodiments may be implemented by instructing relevant hardware through a computer program. The computer program may be stored in a non-transitory computer-readable storage medium. When the computer program is executed, it can implement the processes of the above-mentioned method embodiments. Any reference to a memory, a database or other media used in the embodiments provided in the present disclosure may include at least one of a non-transitory memory and a transitory memory. The non-transitory memory may include a Read-Only Memory (ROM), a magnetic tape, a floppy disk, a flash memory, an optical memory, etc. The transitory memory may include a Random Access Memory (RAM), an external cache memory, or the like. By way of illustration and not limitation, the RAM may be in various forms, such as a Static Random Access Memory (SRAM), or a Dynamic Random Access Memory (DRAM), etc.

The above embodiments of the technical features may be carried out in any combination, in order to make the description concise, not all possible combinations of the technical features of the above embodiments are described. However, as long as the combination of these technical features do not contradict, these technical features should be considered to be within the scope of the description of this specification.

The above-mentioned embodiments only illustrate several embodiments of the present disclosure, and the descriptions thereof are relatively specific and detailed, but should not be construed as a limitation on the scope of the patent of the present disclosure. It should be noted that for those skilled in the art, without departing from the concept of the present disclosure, several modifications and improvements may be made, which all fall within the protection scope of the present disclosure. Therefore, the scope of protection of the present disclosure shall be subject to the appended claims.

What is claimed is:

1. A method for determining unmanned aerial vehicle acquisition viewpoints, wherein the method comprises:
determining target sampling points to be reconstructed from multiple sampling points to be selected on a surface of a scene model based on reconstructabilities of the sampling points to be selected;
for the target sampling points, determining multiple new initial acquisition viewpoints;
selecting target acquisition viewpoints for a reconstruction of the target sampling points from the multiple initial acquisition viewpoints based on viewpoint scores of the initial acquisition viewpoints; and
determining reconstructabilities of unselected sampling points to be selected based on the target acquisition viewpoints, and repeating the step of determining the target sampling points to be reconstructed based on the reconstructabilities of the sampling points to be selected and subsequent steps until a quantity of the sampling points to be selected with the reconstructabilities less than a preset threshold meets a preset condition.

2. The method according to claim 1, wherein the determining the target sampling points to be reconstructed from the multiple sampling points to be selected on the surface of the scene model based on the reconstructabilities of the sampling points to be selected comprises:
for each sampling point to be selected on the surface of the scene model, determining multiple related sampling points within a preset distance from the sampling points to be selected, and determining a sampling probability of the sampling point to be selected based on reconstructabilities of the related sampling points and the reconstructability of the sampling point to be selected; and
sampling the sampling points to be selected with the sampling probabilities to obtain the target sampling points to be reconstructed.

3. The method according to claim 2, wherein the determining the sampling probability of the sampling point to be selected based on the reconstructabilities of the related sampling points and the reconstructability of the sampling point to be selected comprises:
determining distances between the sampling point to be selected and the related sampling points;
obtaining weights of the related sampling points based on the distances, wherein the distances and the weights are negatively related; and
performing a weighted summation of the reconstructabilities of the related sampling points in accordance with the corresponding weights to obtain the sampling probability of the sampling point to be selected.

4. The method according to claim 1, wherein the selecting the target acquisition viewpoints for the reconstruction of the target sampling points from the multiple initial acquisition viewpoints based on the viewpoint scores of the initial acquisition viewpoints comprises:
selecting multiple candidate acquisition viewpoints from the multiple initial acquisition viewpoints based on the viewpoint scores of the initial acquisition viewpoints;
determining redundancies of the candidate acquisition viewpoints;
deleting the candidate acquisition viewpoints with the redundancy greater than a preset redundancy threshold from the multiple candidate acquisition viewpoints to obtain at least two candidate acquisition viewpoints; and
obtaining the target acquisition viewpoints for the reconstruction of the target sampling points based on the at least two candidate acquisition viewpoints.

5. The method according to claim 4, wherein the obtaining the target acquisition viewpoints for the reconstruction of the target sampling points based on the at least two candidate acquisition viewpoints comprises:
for each of the at least two candidate acquisition viewpoints, adjusting a position and an orientation of the candidate acquisition viewpoint using a simple descent method to obtain the target acquisition viewpoints for the reconstruction of the target sampling points.

6. The method according to claim 1, wherein before performing the selecting operation to the multiple initial acquisition viewpoints based on the viewpoint scores of the initial acquisition viewpoints, the method further comprises:
for each initial acquisition viewpoint, determining a spatial vector between the initial acquisition viewpoint and the corresponding target sampling point;
determining an angle between the spatial vector and a normal vector of the target sampling point as an acquisition angle of the initial acquisition viewpoint with respect to the corresponding target sampling point; and
determining the viewpoint score of the initial acquisition viewpoint based on the acquisition angle, wherein the acquisition angle and the viewpoint score are negatively related.

7. The method according to claim 6, wherein each target sampling point has at least one existing acquisition viewpoint, the determining the viewpoint score of the initial acquisition viewpoint based on the acquisition angle comprising:
determining a viewpoint distance between the at least one existing acquisition viewpoint and the initial acquisition viewpoint; and
determining the viewpoint score of the initial acquisition viewpoint based on the acquisition angle and the viewpoint distance.

8. A computer apparatus comprising at least one memory and at least one processor, the at least one memory storing a computer program, wherein when the computer program is executed by the at least one processor, the following steps are implemented:
determining target sampling points to be reconstructed from multiple sampling points to be selected on a surface of a scene model based on reconstructabilities of the sampling points to be selected;
for the target sampling points, determining multiple new initial acquisition viewpoints;
selecting target acquisition viewpoints for a reconstruction of the target sampling points from the multiple initial acquisition viewpoints based on viewpoint scores of the initial acquisition viewpoints; and
determining reconstructabilities of unselected sampling points to be selected based on the target acquisition viewpoints, and repeating the step of determining the target sampling points to be reconstructed based on the reconstructabilities of the sampling points to be selected and subsequent steps until a quantity of the sampling points to be selected with the reconstructabilities less than a preset threshold meets a preset condition.

9. The computer apparatus according to claim 8, wherein the determining the target sampling points to be reconstructed from the multiple sampling points to be selected on the surface of the scene model based on the reconstructabilities of the sampling points to be selected comprises:
for each sampling point to be selected on the surface of the scene model, determining multiple related sampling points within a preset distance from the sampling points to be selected, and determining a sampling probability of the sampling point to be selected based on reconstructabilities of the related sampling points and the reconstructability of the sampling point to be selected; and
sampling the sampling points to be selected with the sampling probabilities to obtain the target sampling points to be reconstructed.

10. The computer apparatus according to claim 9, wherein the determining the sampling probability of the sampling point to be selected based on the reconstructabilities of the related sampling points and the reconstructability of the sampling point to be selected comprises:
determining distances between the sampling point to be selected and the related sampling points;
obtaining weights of the related sampling points based on the distances, wherein the distances and the weights are negatively related; and
performing a weighted summation of the reconstructabilities of the related sampling points in accordance with the corresponding weights to obtain the sampling probability of the sampling point to be selected.

11. The computer apparatus according to claim 8, wherein the selecting the target acquisition viewpoints for the reconstruction of the target sampling points from the multiple initial acquisition viewpoints based on the viewpoint scores of the initial acquisition viewpoints comprises:
selecting multiple candidate acquisition viewpoints from the multiple initial acquisition viewpoints based on the viewpoint scores of the initial acquisition viewpoints;
determining redundancies of the candidate acquisition viewpoints;
deleting the candidate acquisition viewpoints with the redundancy greater than a preset redundancy threshold from the multiple candidate acquisition viewpoints to obtain at least two candidate acquisition viewpoints; and
obtaining the target acquisition viewpoints for the reconstruction of the target sampling points based on the at least two candidate acquisition viewpoints.

12. The computer apparatus according to claim 11, wherein the obtaining the target acquisition viewpoints for the reconstruction of the target sampling points based on the at least two candidate acquisition viewpoints comprises:
for each of the at least two candidate acquisition viewpoints, adjusting a position and an orientation of the candidate acquisition viewpoint using a simple descent method to obtain the target acquisition viewpoints for the reconstruction of the target sampling points.

13. The computer apparatus according to claim 8, wherein before performing the selecting operation to the multiple initial acquisition viewpoints based on the viewpoint scores of the initial acquisition viewpoints, the steps further comprise:
for each initial acquisition viewpoint, determining a spatial vector between the initial acquisition viewpoint and the corresponding target sampling point;
determining an angle between the spatial vector and a normal vector of the target sampling point as an acquisition angle of the initial acquisition viewpoint with respect to the corresponding target sampling point; and
determining the viewpoint score of the initial acquisition viewpoint based on the acquisition angle, wherein the acquisition angle and the viewpoint score are negatively related.

14. The computer apparatus according to claim 13, wherein each target sampling point has at least one existing acquisition viewpoint, the determining the viewpoint score of the initial acquisition viewpoint based on the acquisition angle comprising:
determining a viewpoint distance between the at least one existing acquisition viewpoint and the initial acquisition viewpoint; and
determining the viewpoint score of the initial acquisition viewpoint based on the acquisition angle and the viewpoint distance.

15. A non-transitory computer readable storage medium, on which a computer program is stored, wherein when the computer program is executed by at least one processor, the following steps are implemented:
determining target sampling points to be reconstructed from multiple sampling points to be selected on a surface of a scene model based on reconstructabilities of the sampling points to be selected;
for the target sampling points, determining multiple new initial acquisition viewpoints;
selecting target acquisition viewpoints for a reconstruction of the target sampling points from the multiple initial acquisition viewpoints based on viewpoint scores of the initial acquisition viewpoints; and
determining reconstructabilities of unselected sampling points to be selected based on the target acquisition viewpoints, and repeating the step of determining the target sampling points to be reconstructed based on the reconstructabilities of the sampling points to be selected and subsequent steps until a quantity of the sampling points to be selected with the reconstructabilities less than a preset threshold meets a preset condition.

16. The non-transitory computer readable storage medium according to claim 15, wherein the determining the target sampling points to be reconstructed from the multiple sampling points to be selected on the surface of the scene model based on the reconstructabilities of the sampling points to be selected comprises:
for each sampling point to be selected on the surface of the scene model, determining multiple related sampling points within a preset distance from the sampling points to be selected, and determining a sampling probability of the sampling point to be selected based on reconstructabilities of the related sampling points and the reconstructability of the sampling point to be selected; and
sampling the sampling points to be selected with the sampling probabilities to obtain the target sampling points to be reconstructed.

17. The non-transitory computer readable storage medium according to claim 16, wherein the determining the sampling probability of the sampling point to be selected based on the reconstructabilities of the related sampling points and the reconstructability of the sampling point to be selected comprises:
determining distances between the sampling point to be selected and the related sampling points;
obtaining weights of the related sampling points based on the distances, wherein the distances and the weights are negatively related; and
performing a weighted summation of the reconstructabilities of the related sampling points in accordance with the corresponding weights to obtain the sampling probability of the sampling point to be selected.

18. The non-transitory computer readable storage medium according to claim 15, wherein the selecting the target acquisition viewpoints for the reconstruction of the target sampling points from the multiple initial acquisition viewpoints based on the viewpoint scores of the initial acquisition viewpoints comprises:
selecting multiple candidate acquisition viewpoints from the multiple initial acquisition viewpoints based on the viewpoint scores of the initial acquisition viewpoints;
determining redundancies of the candidate acquisition viewpoints;
deleting the candidate acquisition viewpoints with the redundancy greater than a preset redundancy threshold from the multiple candidate acquisition viewpoints to obtain at least two candidate acquisition viewpoints; and
obtaining the target acquisition viewpoints for the reconstruction of the target sampling points based on the at least two candidate acquisition viewpoints.

19. The non-transitory computer readable storage medium according to claim 18, wherein the obtaining the target acquisition viewpoints for the reconstruction of the target sampling points based on the at least two candidate acquisition viewpoints comprises:
for each of the at least two candidate acquisition viewpoints, adjusting a position and an orientation of the candidate acquisition viewpoint using a simple descent method to obtain the target acquisition viewpoints for the reconstruction of the target sampling points.

20. The non-transitory computer readable storage medium according to claim 15, wherein before performing the selecting operation to the multiple initial acquisition viewpoints based on the viewpoint scores of the initial acquisition viewpoints, the steps further comprises:
for each initial acquisition viewpoint, determining a spatial vector between the initial acquisition viewpoint and the corresponding target sampling point;
determining an angle between the spatial vector and a normal vector of the target sampling point as an acquisition angle of the initial acquisition viewpoint with respect to the corresponding target sampling point; and
determining the viewpoint score of the initial acquisition viewpoint based on the acquisition angle, wherein the acquisition angle and the viewpoint score are negatively related.
